(19) United States
(12) Patent Application Publication
(10) Pub. No.: US 2006/0248128 A1
(43) Pub. Date: Nov. 2, 2006

(54) Efficient mechanism for tracking data changes in a database system

(75) Inventors: Srinivasmurthy P. Acharya, Sammamish, WA (US); Amit Shukla, Redmond, WA (US); Siddhartha Singh, Sammamish, WA (US); Nigel R. Ellis, Redmond, WA (US); Lev Novik, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/118,572

(22) Filed: Apr. 29, 2005

(51) Int. Cl. G06F 17/30

(52) U.S. Cl. 707/203

(57) ABSTRACT

The subject invention provides a system and/or a method that facilitates tracking a data change to an entity within a data storage system at an entity level and at a sub-entity level. The data storage system can be a database-based file system, wherein an interface can receive at least one data change to an entity within the data storage system that in part represents complex instances of types. A track component can track additional data change information of one or more sub-entity levels of the entity when the entity participates in a synchronization (sync) relationship.

### TECHNICAL FIELD

The present invention generally relates to databases, and more particularly to systems and/or methods that facilitate tracking a data change and/or manipulation within a data storage system.

### BACKGROUND OF THE INVENTION

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. Today, a common approach is to store electronic data in one or more databases. In general, a typical database can be referred to as an organized collection of information with data structured such that a computer program can quickly search and select desired pieces of data, for example. Commonly, data within a database is organized via one or more tables. Such tables are arranged as an array of rows and columns.

Also, the tables can comprise a set of records, wherein a record includes a set of fields. Records are commonly indexed as rows within a table and the record fields are typically indexed as columns, such that a row/column pair of indices can reference particular datum within a table. For example, a row can store a complete data record relating to a sales transaction, a person, or a project. Likewise, columns of the table can define discrete portions of the rows that have the same general data format, wherein the columns can define fields of the records.

Each individual piece of data, standing alone, is generally not very informative. Database applications make data more useful because they help users organize and process the data. Database applications allow the user to compare, sort, order, merge, separate and interconnect the data, so that useful information can be generated from the data. Capacity and versatility of databases have grown incredibly to allow virtually endless storage capacity utilizing databases. However, typical database systems offer limited query-ability based upon time, file extension, location, and size. For example, in order to search the vast amounts of data associated to a database, a typical search is limited to a file name, a file size, a date of creation, etc., wherein such techniques are deficient and inept.

With a continuing and increasing creation of data from end-users, the problems and difficulties surrounding finding, relating, manipulating, and storing such data is escalating. End-users write documents, store photos, rip music from compact discs, receive email, retain copies of sent email, etc. For example, in the simple process of creating a music compact disc, the end-user can create megabytes of data. Ripping the music from the compact disc, converting the file to a suitable format, creating a jewel case cover, and designing a compact disc label, all require the creation of data.

Not only are the complications surrounding users, but developers have similar issues with data. Developers create and write a myriad of applications varying from personal applications to highly developed enterprise applications. While creating and/or developing, developers frequently, if not always, gather data. When obtaining such data, the data needs to be stored. In other words, the problems and difficulties surrounding finding, relating, manipulating, and storing data affect both the developer and the end user. In particular, the tracking of a data change and/or manipulation associated with such escalating amounts of data can prove to be an impossible task.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and/or methods that facilitate tracking a data change at an entity level and/or an entity sub-level based at least in part upon the participation of a synchronization relationship. A data storage system can be a database-based file storage system that includes an item, a sub-item, a property, and a relationship to define the representation of information within a data storage system as instances of complex types. In order to facilitate tracking a data change, a track component can provide a granular tracking of a data change to an entity within the data storage system. For example, data changes can be captured at an entity level, and if the entity participates in a sync relationship, the data changes can be captured at any sub-entity level. In other words, the track component can track a data change within the data storage system at sub-entity levels based at least in part upon synchronization participation. The data change can include a copy, an update, a replace, a get, a set, a create, a delete, a move, and a modify to any entity within the data storage system. Moreover, the entity can be an item, a relationship, an extension, an item extension, a link, and an item fragment.

In accordance with one aspect of the subject invention, the track component can include a non-sync component. The non-sync component can provide tracking and/or data capturing to an entity within the data storage system that does not participate in synchronization. Specifically, the non-sync component can track at least one of a creation local time stamp, a last update local time stamp, and a sync information related to the entity. Furthermore, the track component can include a sync component. The sync component can provide data capturing and/or tracking to an entity within the data storage system that participates in a sync relationship. In particular, the sync component can track a creation partner key, a creation partner time stamp, a last update partner key, a deletion coordinated universal time (UTC), and a change unit version related to the entity when participating in a sync relationship.

In accordance with another aspect of the subject invention, the track component can implement a change information structure that carefully segments the data captured for generic change tracking from the data captured for the exclusive use of sync infrastructure. The change information structure can capture data changes at the entity levels as well as sub-entity levels to facilitate the synchronization of minimal amount of data that was affected by the data change within the data storage system. By providing a granular tracking and/or capturing of data changes associated with an entity, the synchronization of data between two disparate systems can be proportional in relation to the system resources necessary for such synchronization. For instance, a schema definition language can provide annotation facilities in the type declaration to group a set of properties in an entity into logical units called change units. A change unit groups a set of properties into a logical unit on which change information can be captured within the data storage system. This information can be utilized to detect changes at sub-entity levels.

In accordance with still another aspect, the track component can include a non-sync maintenance component that maintains a data change information related to an entity within the data storage system. The non-sync maintenance component can maintain a creation local time stamp and a last update local time stamp for the entity to be utilized with at least one of a notification and an optimistic concurrency control. In addition, the track component can include a sync maintenance component to maintain a data change information related to an entity that participates in a sync relationship within the data storage system. Particularly, the sync maintenance component can maintain a sync information related to an entity when a subsequent update is invoked.

In accordance with another aspect of the subject invention, the track component can include a generate component that can generate a default sync change information structure for an entity that starts participating in a sync relationship. The generate component can pre-compute a default sync change information object for each type of object installed in the data storage system during a schema installation. Furthermore, the track component can include an update component that provides a status of sync participation for the entity to allow the tracking of sub-entity levels within the data storage system. In another aspect, the track component can further include a cleanup component that can delete an orphan sync information enabled entity. In other aspects of the subject invention, methods are provided that facilitate tracking a data change.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates tracking data changes in a data storage system.

FIG. 2 illustrates a block diagram of an exemplary system that facilitates tracking data changes in a data storage system for a synchronized entity and a non-synchronized entity.

FIG. 3 illustrates a block diagram of an exemplary system that facilitates tracking data changes at entity and sub-entity levels for all entities stored in a data storage system.

FIG. 4 illustrates a block diagram of an exemplary system that facilitates providing maintenance to tracked data changes to an entity within a data storage system.

FIG. 5 illustrates a block diagram of an exemplary system that facilitates tracking data changes in a data storage system.

FIG. 6 illustrates a block diagram of an exemplary system that facilitates tracking data changes at entity and sub-entity levels for all entities stored in a data storage system.

FIG. 7 illustrates an exemplary methodology for tracking data changes in a data storage system.

FIG. 8 illustrates an exemplary methodology for tracking data changes at entity and sub-entity levels for all entities stored in a data storage system.

FIG. 9 illustrates an exemplary networking environment, wherein the novel aspects of the subject invention can be employed.

FIG. 10 illustrates an exemplary operating environment that can be employed in accordance with the subject invention.

### DESCRIPTION OF THE INVENTION

As utilized in this application, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

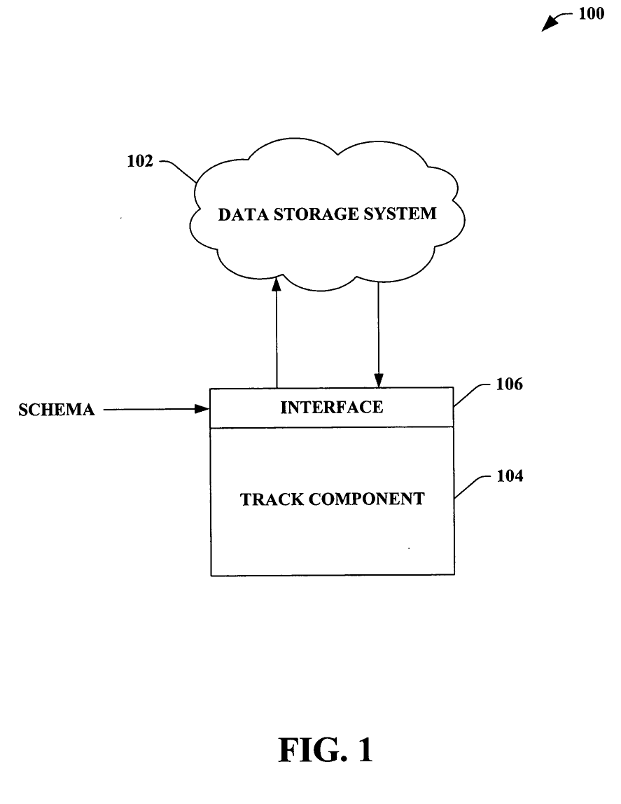

Now turning to the figures, FIG. 1 illustrates a system 100 that facilitates tracking data changes in a data storage system. A data storage system 102 can be a complex model based at least upon a database structure, wherein an item, a sub-item, a property, and a relationship are defined to allow representation of information within a data storage system as instances of complex types. The data storage system 102 can utilize a set of basic building blocks for creating and managing rich, persisted objects and links between objects. An item can be defined as the smallest unit of consistency within the data storage system 102, which can be independently secured, serialized, synchronized, copied, backup/restored, etc. The item is an instance of a type, wherein all items in the data storage system 102 can be stored in a single global extent of items. The data storage system 102 can be based upon at least one item and/or a container structure. Moreover, the data storage system 102 can be a storage platform exposing rich metadata that is buried in files as items. It is to be appreciated that the data storage system 102 can represent a database-based file storage system to support the above discussed functionality, wherein any suitable characteristics and/or attributes can be implemented. Furthermore, the data storage system 102 can utilize a container hierarchical structure, wherein a container is an item that can contain at least one other item. The containment concept is implemented via a container ID property inside the associated class. A store can also be a container such that the store can be a physical organizational and manageability unit. In addition, the store represents a root container for a tree of containers within the hierarchical structure.

A track component 104 can track at least one data change (e.g., a copy, an update, a replace, a get, a set, a create, a delete, a move, and a modify) within the data storage system 102, wherein such data change can be associated with an entity and sub-entity level for any and/or all entities stored within the data storage system 102. The track component 104 can capture the data change(s) to the entities to facilitate synchronizing data between two systems maintaining substantially similar sets of data. The track component 104 can utilize a schema that provides an infrastructure that allows a store and/or container to provide granular maintenance in relation to a data change. By invoking such schema, the track component 104 can provide an efficient mechanism to capture and maintain data changes within the data storage system 102. In other words, the track component 104 can identify data that is marked for synchronization and avoids expensive data change tracking for other entities. It is to be appreciated that the track component 104 can provide granular tracking on at least one data change associated with the data storage system 102, wherein the granular tracking can be on an entity, a sub-entity, a sub-sub-entity, etc.

For example, an item, extension, and/or link can be considered an entity within the data storage system 102. If such entity does not participate in a synchronization relationship (also referred to as a “sync relationship”), the maintenance of certain data changes can be postponed until such entity begins participation in synchronization (also referred to as “sync”). For instance, the schema can be designed that carefully segments the data capture for a generic data change tracking from the data captured for the exclusive use of synchronization infrastructure. The schema can capture data changes at an entity level as well as sub-entity levels to facilitate the synchronization of minimal amount of data that was affected.

The system 100 further includes an interface component 106, which provides various adapters, connectors, channels, communication paths, etc. to integrate the track component 104 into virtually any operating and/or database system(s). In addition, the interface component 106 can provide various adapters, connectors, channels, communication paths, etc. that provide for interaction with the data storage system 102, the schema, and the track component 104. It is to be appreciated that although the interface component 106 is incorporated into the track component 104, such implementation is not so limited. For instance, the interface component 106 can be a stand-alone component to receive or transmit data in relation to the system 100.

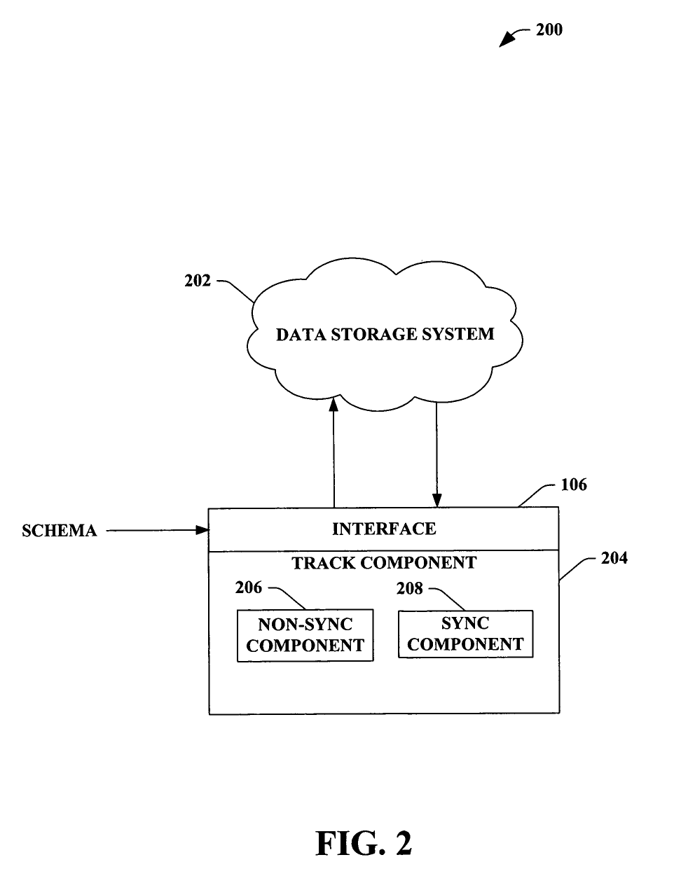

FIG. 2 illustrates a system 200 that facilitates tracking data changes in a data storage system for a synchronized entity and a non-synchronized entity. A data storage system 202 can be a database-based file storage system that represents instances of data as complex types by utilizing at least a hierarchical structure. An item, a sub-item, a property, and a relationship can be defined within the data storage system 202 to allow the representation of information as instances of complex types. The data storage system 202 can be a data model that can describe a shape of data, declare constraints to imply certain semantic consistency on the data, and define semantic associations between the data. The data storage system 202 can utilize a set of basic building blocks for creating and managing rich, persisted objects and links between objects.

For instance, the building blocks can include an “Item,” an “ItemExtension,” a “Link,” and an ItemFragment.” An “Item” can be defined as the smallest unit of consistency within the data storage system 202, which can be independently secured, serialized, synchronized, copied, backup/restored, etc. The item is an instance of a type, wherein all items in the data storage system 202 can be stored in a single global extent of items. An “ItemExtension” is an item type that is extended utilizing an entity extension. The entity extension can be defined in a schema with respective attributes (e.g., a name, an extended item type, a property declaration, . . . ). The “ItemExtension” can be implemented to group a set of properties that can be applied to the item type that is extended. A “Link” is an entity type that defines an association between two item instances, wherein the links are directed (e.g., one item is a source of the link and the other is the target of the link). An “ItemFragment” is an entity type that enables declaration of large collections in item types and/or item extensions, wherein the elements of the collection can be an entity. It is to be appreciated and understood that the data storage system 202 can represent any suitable database-based file storage system that provides the representation of data as instances of complex types and the above depiction is not to be seen as limiting the subject invention. The data storage system 202 can be substantially similar to the data storage system 102 depicted in FIG. 1.

A track component 204 can provide tracking data changes to various entities stored inside the data storage system 202, and in particular, a store within the data storage system 202. The track component 204 can capture the data change(s) to the entities to facilitate synchronizing data between two disparate systems maintaining sets of data. The track component 204 can utilize a schema that provides an infrastructure that allows a store and/or container to provide granular maintenance in relation to a data change. For instance, the track component 204 can track a data change, wherein the data change can include, an insert, an update, and a delete at the entity (e.g., item, relationship, extension, etc.) level. The track component 204 can track data changes such that at the entity level, the change tracking can be utilized to generate at least one of a notification and control with optimistic concurrency. It is to be appreciated that optimistic concurrency assumes the likelihood of another process making a change at the substantially similar time is low, so it does not take a lock until the change is ready to be committed to the data storage system (e.g., store). By employing such technique, the lock time is reduced and database performance is better. The track component 204 can be substantially similar to the track component 104 of FIG. 1.

The track component 204 can include a non-sync component 206 that can track data changes at an entity level within the data storage system 202. It is to be appreciated that the data changes are tracked solely at an entity level based at least in part upon the non-participation in synchronization. Tracking a data change at the entity level can be referred to as “change information.” The non-sync component 206 can capture basic change information for all entities. For instance, the basic change information can be, but is not limited to, a local creation time and a local modification time.

The track component 204 can further include a sync component 208 that provides tracking for an entity that participates in synchronization. The sync component 208 has a more specialized requirement to track data changes to an entity at a more granular level as well as capturing and maintaining information about the store and/or container that has been changed in a multi-store replication (e.g., castle) scenario. The sync component 208 can capture addition change information for entities in a sync relationship. For instance, the sync component 208 can capture change information at a more granular (e.g., sub-level, sub-sub-level, etc.) to minimize the amount of data to be synchronized and to reduce the number of change conflict situations. In another example, the sync component 208 can capture information about which store and/or container created and/or updated entities. In addition, maintaining a tombstone (discussed infra) of an entity after deletion from a store and/or container can be captured to allow the sync component 208 to maintain the deletions and propagate them to other stores during synchronization. It is to be appreciated that the sync component 208 provides the change information capture in such a design that implementation is efficient such that additional sync related change information is maintained only for sync entities.

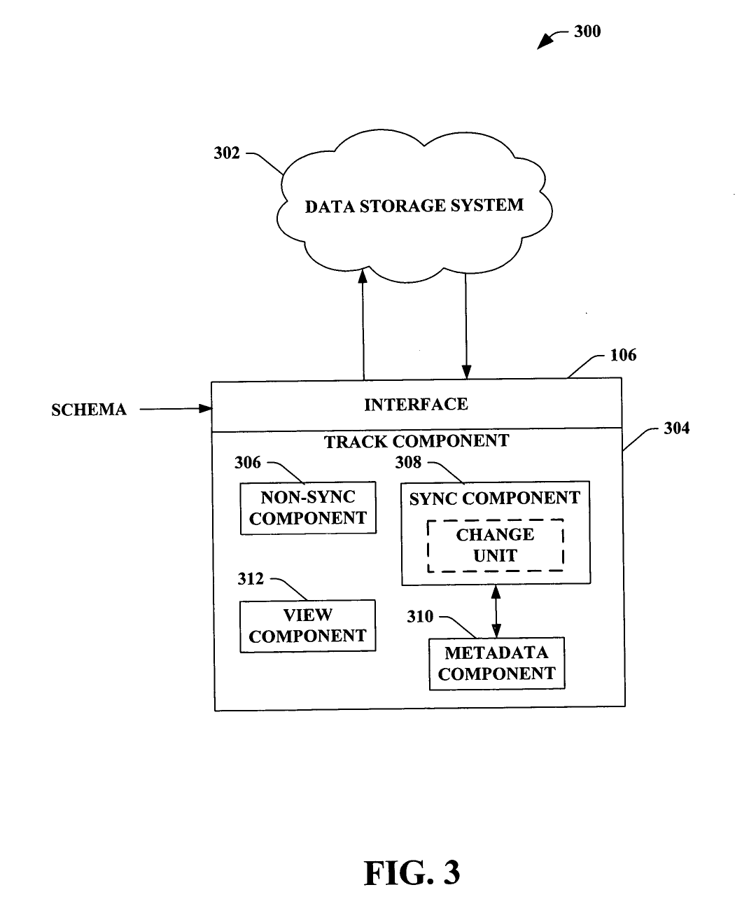

FIG. 3 illustrates a system 300 that facilitates tracking data changes at entity and sub-entity levels for all entities stored in a data storage system. A data storage system 302 can be a database-based file storage system, wherein data is represented as instances of complex types. A track component 304 can provide tracking of at least one data change within the data storage system 302. It is to be appreciated and understood that the data storage system 302 and the track component 304 can be substantially similar to the data storage system 202 and 102 and the track component 204 and 104 of FIG. 2 and 1 respectively.

The track component 304 can include a non-sync component 306 that can track and/or capture basic change information that relates to a data change to an entity that does participate with synchronization within the data storage system 302. Basic information can be captured for any and/or all entities (e.g., items, relationships, and extensions, etc.) in the data storage system 302, and more particularly, a store within such data storage system 302. For example, the following table describes the basic change information captured for all entities within the data storage system 302.

| Property Name | Type | Description |
|---|---|---|
| CreationLocalTS | Int64 | Local timestamp |
| | | corresponding to |
| | | the entity creation |
| | | in the local store |
| LastUpdateLocalTS | Int64 | Local timestamp |
| | | corresponding to |
| | | the last update |
| | | time in the local |
| | | store |
| SyncInformation | SyncEntityVersion | Additional informa- |
| | | tion captured only |
| | | for entities parti- |
| | | cipating in a Sync |
| | | relationship |

The track component 304 can further include a sync component 308 that tracks a data change for an entity at a granular level based at least in part upon the participation of synchronization on the part of such entity. In other words, for entities (e.g., items, relationships, extensions, etc.) in a sync relationship, additional change information about the details of the partner stores that created and/or updated an entity can be captured. In addition, change information at sub-entity levels can be captured for efficient operation of entity synchronization and/or conflict detection. Such information captured for entities involved in a sync relationship can be referred to as “SyncEntityVersion.” The sync component 308 can utilize the SyncEntityVersion to facilitate synchronization of entities between multiple stores within the data storage system 302. The following table can be an example of SyncEntityVersion information.

| Property Name | Type | Description |
|---|---|---|
| CreationPartnerKey | Int32 | Partner Key of |
| | | the entity |
| | | creating Partner |
| CreationPartnerTS | Int64 | Creation |
| | | TimeStamp |
| LastUpdatePartnerKey | Int32 | Partner Key of |
| | | the partner who |
| | | last updated the |
| | | entity. |
| LastUpdatePartnerTS | Int64 | Last update |
| | | TimeStamp |
| DeletionUTC | DateTime | UTC timestamp |
| | | of entity deletion |
| ChangeUnitVersions | MultiSet<ChangeUnit | A set of change |
| | Version> | information main- |
| | | tained at sub- |
| | | entity level |
| | | (ChangeUnitVersions) |
| | | These |
| | | ChanageUnitVersions |
| | | track change infor- |
| | | mation for a set |
| | | of predefined |
| | | groupings of |
| | | properties in an |
| | | item/relationship/ |
| | | extension. |

The sync component 308 can utilize a change unit to group a set of properties into a logical unit on which change information can be captured within the data storage system 302, and in particular, a store within the data storage system 302. For entities involved in a sync relationship, synchronization of all information in an entity when a specific property or a group of properties has changed is inefficient. A schema can define language to provide annotation facilities in the type declaration to group a set of properties in an item, relationship, or extension into logical units known as “change units.” The change unit information can be utilized by the sync component 308 to detect changes at sub-entity levels and to efficiently send/process change information for conflict detection. It is to be appreciated that if any property in a change unit is updated, the change unit must be updated.

In one example, a data storage system schema language (e.g., extensible markup language (XML) declarations, etc.) can provide a technique to declare a change unit by utilizing a “ChangeUnit” element declaration inside a type definition. ChangeUnit elements can have the following attributes: a name (e.g., the name of the change unit), and an identification (ID) (e.g., an integer identifying the change unit that can be unique among the change units in a type). For instance, each root entity (e.g., item, extension, and relationship) can define a change unit that has the same name of the entity. For example, “Item” defines a change unit called “Item.” It is to be appreciated that once declared, this change unit can be associated with one or more top level properties by utilizing a “ChangeUnit” attribute with that property declaration.

The following is an example of schema definition, wherein such example is not to be seen as limiting on the subject invention.

<!-- A change unit called PersonalInfo in the type
System.Storage.Contacts.Person. -->
<EntityType Name=“Person” BaseType=“DSS.Item”>

. . .
<ChangeUnit Name=“PersonalInfo” Id=“3”/>
. . .
<Property Name=“Age” Type=“DSS.Int16”

ChangeUnit=“PersonalInfo”/>

. . .

</ItemType>

If a subtype of Person adds a property to the “PersonalInfo” change unit, it can utilize syntax substantially similar to that of property “Person.Age” as depicted above.

The change unit can have various properties and/or behaviors associated therewith. For instance, the following can be behaviors associated to the change units: 1) every property can be a member of exactly one change unit (e.g., one exception can be fields in the base schema, where immutable fields like ItemID are not tracked); 2) change units can contain top level properties of an entity (e.g., not properties inside nested types); 3) change units can be defined utilizing an XML schema declaration before they can be implemented; 4) change unit ID number are unique among the change units in a type; 5) once a change unit has been defined, properties can be added to it; and 6) a change unit is associated with a type, and type that inherit from that type can add properties to the change unit.

The following is illustrated as a concrete schema example for contact item, wherein “ChangeUnit” keyword identifies the grouping of properties that allows change tracking at sub-entity levels. The pseudo code below is only one example, and is not to be limiting on the subject invention.

<EntityType Name=“Contact” BaseType=“DataStorageSystem.Item”

TypeId=“3ce74c67-7454-44c2-8b29-bef9666d8c7d”>

<Documentation>The Core Contact type represents either an
Organization or a

Person that has a meaningful name and can be
contacted in some
way.</Documentation>

<ChangeUnit Name=“EAddressesCu” Id=“1” />
<ChangeUnit Name=“NotesCu” Id=“2” />
<ChangeUnit Name=“UserTileCu” Id=“3” />
<ChangeUnit Name=“PostalAddressesCu” Id=“4” />

− <Property Name=“EAddresses” Type=“Array(Core.EAddress)”

ChangeUnit=“EAddressesCu”>

<Documentation>EAddress nested element collection references.
This could

include references to SMTPEmail, TelephoneNumber
and/or
InstantMessagingAddress. None, one or more EAddress
references are
acceptable. This collection will contain all eaddresses
for the contact including
their work eaddresses, the label may be sued to
indicate the company name for
work-related eaddresses.</Documentation>

</Property>

− <Property Name=“PostalAddresses”
Type=“Array(Core.PostalAddress)”

ChangeUnit=“PostalAddressesCu”>

<Documentation>Postal address(es) of the
Contact.</Documentation>

</Property>

− <Property Name=“Notes” Type=“Array(Core.RichText)”

ChangeUnit=“NotesCu”>

<Documentation> Any free form text that the user wants to enter
about the Contact.

The format can be any type of rich or plain text.
None, one or more
Documentation references is possible.</Documentation>

</Property>

− <Property Name=“UserTile” Type=“DataStorageSystem.Binary”
Size=“max”

Nullable=“true” ChangeUnit=“UserTileCu”>

<Documentation>UserTile is the Binary tile that represents the
Contact on the log-

on screen and in any Shell UI. For example, the frog
or duck Binary. UserTile
differs from the Contacts.Person.PersonalPicture
property in that it is
specifically used for the log-on screen and Shell UI,
whereas PersonalPicture is
any Binary that is associated with the
Person.</Documentation>

</Property>

</EntityType>

The sync component 308 can track versioning information for each ChangeUnit defined on a type instance. This information can be stored in the type ChangeunitVersion defined in the schema (e.g., System.Storage.schema, etc.). For instance, a ChangeUnitVersion can contain the following information depicted in the table below.

| SyncChangeUnitVersion | | |
|---|---|---|
| Property Name | Type | Description |
| ChangeUnitId | Int16 | Internally generated |
| | | ID that uniquely |
| | | Identifies a change |
| | | unit |
| LastUpdateLocalTS | Int64 | Timestamp on the |
| | | local machine when |
| | | a property in this |
| | | change unit was |
| | | last updated |
| LastUpdatePartnerKey | Int32 | Partner Key of the |
| | | partner who last |
| | | updated this change |
| | | unit. |
| LastUpdatePartnerTS | Int64 | Last update |
| | | TimeStamp |
| BasedOnVersions | Array<SyncVersion> | Used to store |
| | | conflict information. |
| | | Each SyncVersion |
| | | contains a pair of |
| | | values consisting |
| | | of <PartnerKey, |
| | | PartnerType> |
| LastUpdateUTC | DateTime | UTC time at last |
| | | updating partner |
| | | (for local update, |
| | | this is the local |
| | | UTC time) |

Furthermore, based at least in part upon the descriptions above, the change information for entities within the data storage system 302 can be captured by the following example schema. It is to be appreciated that the below schema is only an example and the subject invention is not limited to such schema. Moreover, the data storage system is referred to as “DSS” in the pseudo code below.

<!--A sync version from a sync partner -->
<InlineType Name=“SyncVersion” BaseType=“DSS.InlineType” >

<Property Name=“PartnerKey” Type=“ DSS.Int32” Nullable=“false” />
<Property Name=“PartnerTS” Type=“ DSS.Int64” Nullable=“false” />

</InlineType>
<!— A ChangeUnitVersion -->
<InlineType Name=“SyncChangeUnitVersion” BaseType=“ DSS.InlineType” >

| | |
|---|---|
| <Property Name=“ChangeUnitId” | Type=“ DSS.Int16” |

Nullable=“false” />

| | |
|---|---|
| <Property Name=“LastUpdateLocalTS” | Type=“ DSS.Int64” |

Nullable=“false” />

| | |
|---|---|
| <Property Name=“LastUpdatePartnerKey” | Type=“ DSS.Int32” |

Nullable=“false” />

| | |
|---|---|
| <Property Name=“LastUpdatePartnerTS” | Type=“ DSS.Int64” |

Nullable=“false” />

| | |
|---|---|
| <Property Name=“BasedOnVersions” | Type=“Array(SyncVersion)” /> |
| <Property Name=“LastUpdateUTC” | Type=“ DSS.DateTime” |

Nullable=“false” />
</InlineType>
<!— Sync specific change Information captured for entities in a sync relationship
-->
<InlineType Name=“SyncEntityVersion” BaseType=“ DSS.InlineType”
Nullable=“false” >

| | |
|---|---|
| <Property Name=“CreationPartnerKey” | Type=“ DSS.Int32” |

Nullable=“false” />

| | |
|---|---|
| <Property Name=“CreationPartnerTS” | Type=“ DSS.Int64” |

Nullable=“false” />

| | |
|---|---|
| <Property Name=“LastUpdatePartnerKey” | Type=“ DSS.Int32” |

Nullable=“false” />

| | |
|---|---|
| <Property Name=“LastUpdatePartnerTS” | Type=“ DSS.Int64” |

Nullable=“false” />

| | |
|---|---|
| <Property Name=“DeletionUTC” | Type=“ DSS.DateTime” |

Nullable=“true” />

<Property Name=“

GranularInformation” Type=“Array(SyncChangeUnitVersion)” />
</InlineType>
<!— Change Information captured for entities in the store within the DSS -->
<InlineType Name=“ChangeInformation” BaseType=“ DSS.InlineType” >

<Property Name=“CreationLocalTS” Type=“ DSS.Int64” Nullable=“false”

/>

<Property Name=“LastUpdateLocalTS” Type=“ DSS.Int64”

Nullable=“false” />

<Property Name=“SyncInformation” Type=“

DSS.SyncEntityVersion” Nullable=“true” />
</InlineType>

The track component 304 can further include a metadata component 310 that can maintain a structure referred to as “ItemSyncMetadata” in conjunction with the sync component 308. The ItemSyncMetadata structure stores the mapping of the ItemId and Global ItemId for items participating in a sync relationship. These are sync specific information maintained by the sync component 308 for internal use and may not be used and/or managed by the store within the data storage system 302. In addition, the metadata component 310 can maintain a structure that relates to links and can be referred to as “LinkSyncMetadata.”

The following pseudo code can be implemented in relation to the structures maintained by the metadata component 310. It is to be appreciated that the following is an example that is not to restrict the subject invention, wherein the data storage system is referred to as “DSS” in the pseudo code below.

<InlineType Name=“ItemSyncMetadata” BaseType=“DSS.InlineType” >

<Property Name=“ReplicaItemId” Type=“DSS.Guid”
Nullable=“false” />
<Property Name=“GlobalItemId” Type=“DSS.Guid”
Nullable=“false” />
</InlineType>

<InlineType Name=“LinkSyncMetadata” BaseType=“DSS.InlineType” >

<Property Name=“ReplicaItemId” Type=“DSS.Guid”
Nullable=“false” />
<Property Name=“GlobalLinkId” Type=“DSS.Guid”
Nullable=“false” />
<Property Name=“ConflictingLinkId” Type=“DSS.Guid”
Nullable=“true”

</InlineType>

The track component 304 can include a view component 312 that allows views for all entities to project the change information. For example, the following illustrates such views for all entities within the data storage system 302.

| System.Storage. <Entity> | | |
|---|---|---|
| Column Name | Type | Description |
| _ChangeInformation | System.Storage.Store.ChangeInformation | Change tracking information |
| | | for an entity. |

The track component 302 can further allow an entity table within the data storage system (e.g., Table!Item, Table!Link, Table!Extension, Table!ItemFragment, etc.) to have a single column for storing change information as depicted below.

| Table! <Entity> | | |
|---|---|---|
| Column Name | Type | Description |
| _ChangeInformation | System.Storage.Store.ChangeInformation | Change trackinginformation |
| | | for an entity. |

In addition, the track component 304 can provide an internal table to be invoked by the store within the data storage system 302. For instance, the table can be referred to as “SyncRoots.” The SyncRoots table can contain the root itemids of all the sync roots in the data storage system 302 and is augmented with additional column data called “lowWatermarkTS” which can store a time stamp. This table can be utilized internally by the data storage system 302 to generate sync change information for entities in an item domain identified by a sync root. The following table is an example of the data associated with the SyncRoots table.

| Column Name | Type | Description |
|---|---|---|
| syncRoot | System.Storage.Store.ItemId | Identifies a |
| | | defined sync root |
| | | in the system. |
| lowWatermarkTS | Bigint | TimeStamp that |
| | | indicates the |
| | | maximum time |
| | | until which |
| | | SyncEntityVersion |
| | | has been generated |
| | | for all entities |
| | | in this item |
| | | domain |

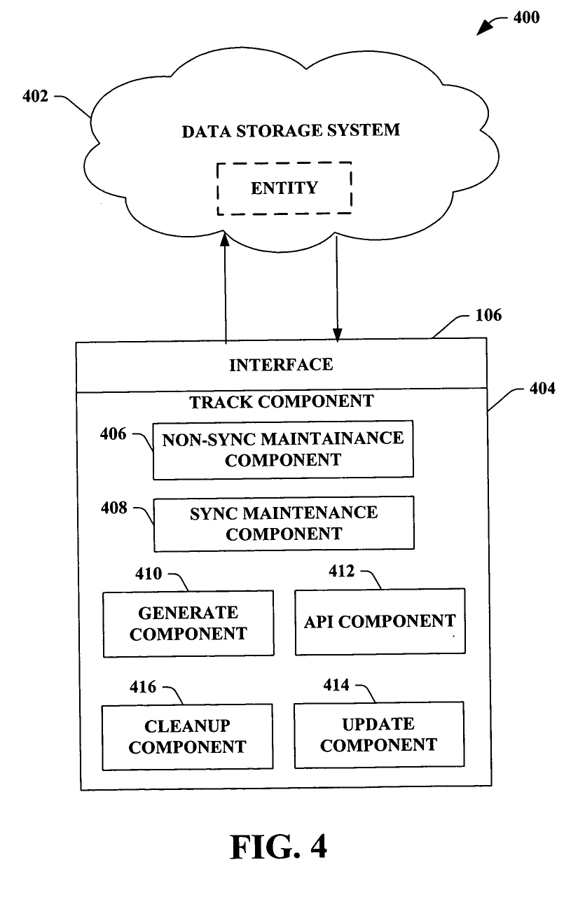

FIG. 4 illustrates a system 400 that facilitates providing maintenance to tracked data changes to an entity within a data storage system. A data storage system 402 can be a database-based file storage system, wherein information is represented as complex instances of types. A track component 404 can track and/or capture a data change with respect to an entity associated with the data storage system 402. It is to be appreciated that the data storage system 402 and the track component 404 can utilize substantially similar functionality as to respective components described in previous figures.

The track component 404 can include a non-sync maintenance component 406 that can maintain the data change information for an entity within the data storage system 402. The maintenance can be maintained for at least one of a creation local time stamp (e.g., CreationLocalTS), a last update local time stamp (e.g., LastUpdateLocalTS), and a sync information (e.g., SyncInformation). For all entities that are not participating in a sync relationship, SyncInformation can be set to NULL and may not be maintained by the system 400. Yet, the other two scalar properties can be maintained for all entities regardless of their sync status. These properties can be utilized with notifications and/or optimistic concurrency control.

The track component 404 can further include a sync maintenance component 408 that provides the maintenance for entities that are in a sync relationship. The locally created and/or modified non-synced items, extensions and relationships have _ChangeInformation.SyncInformation set to NULL. When a user decides to mark an item as participating in Sync, they are actually marking the item domain associated with the item as participating in Sync. At this point, all items in the item domain can participate in sync, and SyncInformation for such items can be computed and stored. Once SyncInformation is set (e.g., to a non NULL value), a store within the data storage system 402 can assume that this entity is participating in a sync relationship and will maintain the needed sync change information for that entity on subsequent updates and/or data changes.

A generate component 410 can generate a default initial sync change information structure for entities that starts participating in a sync relationship. The data storage system 402, and in particular, the store can pre-compute a default SyncChangeInfo object for each type of object installed during a schema installation. This pre-computed value can be stored in a TypeViewLookup table, and a TypeId of the object can be used to lookup the pre-computed SyncChangeInfo object (also referred to as the DefaultSyncInfo). The DefaultSyncInfo object differs from one type to another because the ChangeUnitVersion set contains change units that depend on the type of the object.

The following table can depict the DefaultSyncInfo and the storage associated therewith.

| Property of | | |
|---|---|---|
| _ChangeInformation.SyncInformation | Value | |
| CreationPartnerKey | 0 | |
| CreationPartnerTS | 0 | |
| LastUpdatePartnerKey | 0 | |
| LastUpdatePartnerTS | 0 | |
| DeletionUTC | NULL | |
| GranularInformation | An Array with default values as shown below: | |
| | Property of ChangeUnitVersions | Value |
| | ChangeUnitId | Set to the |
| | | change unit id |
| | LastUpdateLocalTS | 0 |
| | LastUpdatePartnerKey | 0 |
| | LastUpdatePartnerTS | 0 |
| | LastUpdateLocalTS | 0 |
| | BasedOnVersions | NULL |

The track component 404 can further invoke an API component 412 (herein referred to as “API 412”) to allow a user to maintain the tracking and/or capturing of a data change and change information. In one example, a non-sync entity can be maintained by the API 412, wherein the following table can describe associated behavior.

| | CreationLocalTS | LastUpdateLocalTS | SyncInformation |
|---|---|---|---|
| Create Entity | Set to current | Set to current | Set to NULL |
| | timestamp | timestamp | |
| Update | Not updated | Set to current | Not updated |
| Entity | | timestamp | |
| Delete Entity | Not updated | Set to current | Not updated |
| | | timestamp | |

To enable all entities in a sync root for tracking information, the API 42 can invoke an API referenced as “EnableSync.” EnableSync is an operation that enables sync operations for a given sync root (e.g., entities in an item domain). This operation can enumerate all items, relationships, and extensions under the given item domain and generate a default SyncInformation structure for all these entities and assigns them to _ChangeInformation.SyncInformation value of that entity. In one example, the sync component 308 of FIG. 3 and/or the sync component 208 of FIG. 2 can call the EnableSync operation when an item domain is added to a sync relationship.

Once an item domain is enabled for sync, the data storage system 402, and in particular, a store within the data storage system 402 can automatically generate default sync information structures for all entities created under that domain. In other words, whenever a new item, extension, or relationship is added to that sync enabled item domain, the store will generate the default sync information structure at the time of executing that create operation.

The following table is an example that depicts the above.

| Create Operation to add | |
|---|---|
| an entity to the Sync | |
| enabled Root | Enable Sync action |
| CreateItem | Create default sync information structure |
| | for the item and also for the relationship. |
| | If the created item is the root of an item |
| | domain, all the entities in that item |
| | domain (items, relationships, extensions) |
| | are also stamped with default sync |
| | information structure. |
| CreateCompoundItem | See above. |
| CreateLink | Generates default sync information |
| | structure in the relationship. |
| CreateExtension | Generates default sync information |
| | structure in the extension. |
| CreateItemFragment | Generates default sync information |
| | structure in the Itemfragment row. |

In particular, the API 412 can utilize a stored procedure (e.g., also referred to as “EnableSync”) that can enable an item domain for tracking sync change information. By invoking such procedure, the following can be done: 1) inserts a row into System.Storag.Store.[Table!SyncRoots] with the passed in item id; 2) generates default sync information for all entities in that item's domain; and 3) any further addition of items, relationships, extensions into this sync-enabled item domain will result in generation of default sync information structures for these added entities.

The table below can depict a parameter(s) associated with the above stored procedure.

| Parameters | | | |
|---|---|---|---|
| Name | Direction | Type | Description |
| itemId | IN | SqlGuid | Id of the Item whose Item domain |
| | | | needs to be enabled for Sync |
| | | | change information tracking. |

Relating to a read-only share, the sync does not have write permission to the share. However, when sync calls GnerateSyncInfo on a SyncRoot, the API 412 (which has write permissions to all data irrespective of access control lists (ACLs) computes and stores SyncEntityVersion. The SyncEntityVersion on updates to the data after SyncEntityVersion has been computed will be maintained by the sync maintenance component 408.

An update component 412 can provide the updating of a status relating to an entity within the data storage system 402. For instance, an item can be enabled for sync, when previously it had not. In such a case, initial sync change information can be generated, wherein such information needs to be maintained and kept up to date. In one example, an entity can be created, updated, deleted, etc. by the sync component (not shown). In another example, the entity can be created, updated, deleted, etc. by a local application utilizing the API 412.

When an entity is created, updated, deleted, etc. by a sync component, all update APIs (e.g., an API utilized in conjunction with the data storage system that allows data manipulations while enforcing at least one characteristic and/or constraint associated to the data storage system) are augmented with additional parameter(s) to accept SyncEntityVersion. This parameter is for the exclusive use of system 400. The data storage system 402 and the store can enforce a signature validation to ensure that only the system 400 can pass in a non-NULL value for these parameters

The following example shows an API for creating an item. The parameters marked in bold are SyncEntityVersions for data storage system sync usage. It is to be appreciated that all other applications must pass in NULL values for these parameters.

CREATE PROCEDURE [System.Storage.Store].CreateItem

| | |
|---|---|
| @item | [System.Storage.Store].Item, |
| @relationship | [System.Storage.Store].Relationship, |
| @securityDescriptor | [System.Storage.Store].SDDL, |
| @promoStatus | INTEGER, |
| @itemSyncInfo | [System.Storage.Store].SyncEntityVersion, |
| @itemSyncMetadata | [System.Storage.Store].ItemSyncMetadata, |
| @version | BIGINT OUTPUT |

The data storage system sync can compute the SyncChangeInfo and pass in that computed structure to update APIs. When non-NULL values are passed in for these parameters, the store can validate the signature of such caller to ensure that it is an appropriate component within system 400. The store may not do any further validations on the contents of these parameters. The passed in SyncEntityVersion values can be stored in the _ChangeInformation.SyncInformation column for the corresponding entity. The store can also update the values of the local create/update timestamp(s) in the entity table.

For entities participating in a sync relationship, the store maintains SyncEntityVersion for all update operations done through APIs by any non-sync component. In these cases, the corresponding SyncEntityVersion parameters passed in by those applications through the update APIs, will have a NULL value. The store does the following actions to maintain the sync change information in these cases: 1) Create Entity-No action is needed since the entity is new and Sync component has not seen this entity yet and no Generate<Entity>SyncInfo operation has been called on this entity; 2) Update Entity-Need to maintain the change information values (e.g., _LastUpdateLocalTS, set LastUpdateSyncVersion, maintain ChangeUnitVersions set); and 3) Delete Entity-Need to maintain the change information values (e.g., _LastUpdateLocalTS, set LastUpdateUTC, set LastUpdateSyncVersion, set ChangeUnitVersions=NULL).

It is to be appreciated that the update component 414 can disable sync information when an item no longer participates in a sync relationship due to an explicit removal of that sync relationship. The update component 414 can call the store to disable sync change information tracking for that item. This proactive action can stop the unnecessary sync information tracking for that item domain. In one example, the store can provide an API 412 and/or DisableSyncInfo.

The stored procedure DisableSyncInfo can disable an item domain for tracking sync change information. The operation can remove the row with the passed item id from system.storage.[Table!SyncRoots]. The following table and code can be utilized to implement DisableSyncInfo.

| CREATE PROCEDURE [System.Storage.Store].DisableSync | |
|---|---|
| @itemId | [System.Storage.Store].ItemId |

| Parameters | | | |
|---|---|---|---|
| Name | Direction | Type | Description |
| itemId | IN | SqlGuid | Id of the Item whose Item domain |
| | | | needs to be disabled for Sync change |
| | | | information tracking |

The system 400 can utilize a cleanup component 416 that allows the cleanup of the identification of items that are sync information enabled but are not participating in a sync relationship. In one example, the cleanup component 416 can utilize a stored procedure that can generate a triplet. The following pseudo code can provide cleanup for the system 400.

select User, SyncRoot, id.ItemId AS DescendentItemId
from [System.Storage.Store].[Table!SyncRoot] sr
CROSS APPLY [System.Storage.Store].ItemsInDomain(sr.SyncRoot)
id(ItemId)

The result of the above query can be processed as follows: DescendantItemId no longer participates in sync if there is no user who has permission to read it. The steps to be taken when an entity stops participating in sync can be, for instance, Set_ChangeInformation.SyncInformation=NULL and/or CREATE PROCEDURE [System.Storage.Store].CleanupSyncInfo.

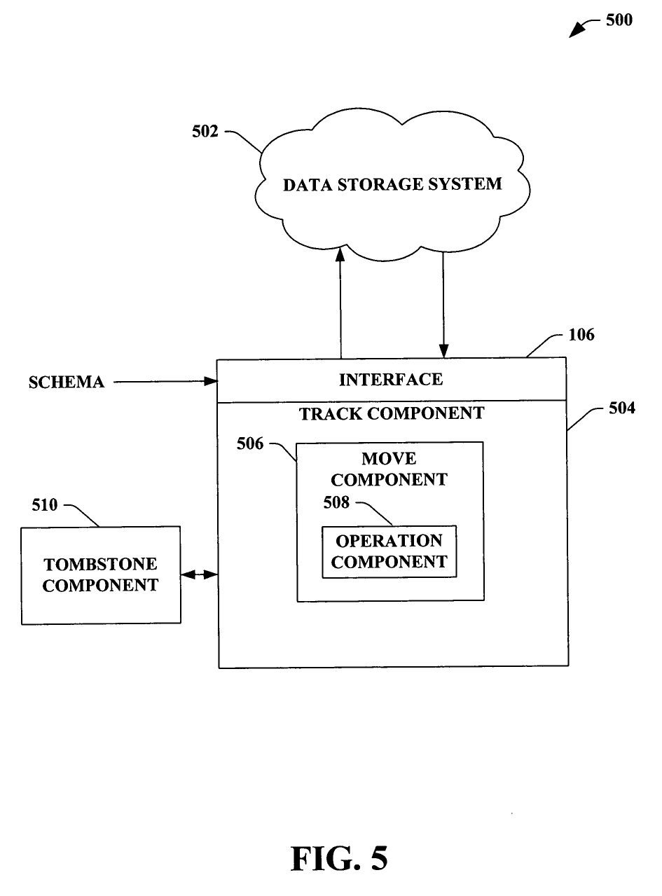

FIG. 5 illustrates a system 500 that facilitates tracking data changes in a data storage system. A data storage system 502 can be a database-based file storage system that represents information as complex instances of types. A track component 504 can track at least one data change associated with the data storage system 502, wherein the data change is tracked at a granular level if participating in a synchronization relationship. It is to be appreciated that the data storage system 502 and the track component 504 can be substantially similar to respective components described in previous figures.

A move component 506 can log information in relation to a move on at least one entity associated with the data storage system 502. A move from one container to another can be represented by a deletion of a holding relationship, and a creation of a holding relationship. The deletion can leave a tombstone, allowing synchronization-minded clients to determine where the item moved from. Such determinations are critical to efficient synchronization, the most important case being the move into the synchronization scope: when a tree of items moves into the scope, all those items need to be sent to synchronization partners, even though the items themselves have not changed. In another example, a move can be represented by changing a parent ID of the moving item, and thus does not naturally leave a trail. Thus, a special Move Tombstone feature can be utilized (e.g., where tombstone represents previously deleted information). For instance, maintaining move logs that record where the item has been in the past can be employed by the move component 506. While technically the tombstones are sufficient for efficient synchronization purposes, the last-move version in the item table is necessary to generate the tombstones.

For instance, when an item moves from one container to another within a store due to a MoveItem( ) operation, the store can log the information about this move into the Table!MoveLog table. The track component 504 can make use of this information during the sync operation. Below is an example of a Table!MoveLog.

| Column name | Type | Description |
|---|---|---|
| ItemId | [System.Storrage.Store].ItemId | ItemId of the |
| | | item that was |
| | | moved |
| OldContainerId | [System.Storrage.Store].ItemId | Container Id of |
| | | the item before |
| | | the move |
| OldPathHandle | [System.Storage.Store].BinPath | Path handle |
| | Handle | before the move |
| LastUpdateLocalTS | Int64 | Last local |
| | | update |
| | | timestamp |
| NewContainerId | [System.Storage.Store].ItemId | Container Id of |
| | | the item after |
| | | the move |
| NewPathHandle | [System.Storage.Store].BinPath | Path handle |
| | Handle | after the move |

The move component 506 can include an operation component 508 that provides operations to the move component 506. Such operation can include, but are not limited to, CreateItem, MoveItem, and DeleteItem operations. With CreateItem, the MoveVersion of the newly-created item is set to null. The MoveItem creates a move log row, wherein the following steps can be performed regardless of whether the item is in the sync scope. A new move log can be generated with the fields assigned as follows: 1) ItemId receives ItemId field of the item being moved; 2) OldContainerId receives old value of ParentId of the item being moved; 3) OldPathHandle receives old value of PathHandle of the item being moved; 4) NewContainerId receives the new value of ParentId of the item being moved; 5) NewPathHandle receives the new value of PathHandle of the item being moved; and 6) LastUpdateLocalTS records the timestamp at the move time. It is to be appreciated that all existing move and/or delete tombstones for this item ID are kept.

A tombstone component 510 can store tombstones in a separate tombstone table, resurrect a tombstone, and/or provide tombstone cleanup. In one example, Item delete can create one tombstone for the item being deleted and no tombstones created for links, EntityExtensions, ItemFragments, and Items deleted by cascading the delete. For instance, an item move operation can create a move tombstone for the item being move. A move can result in all content “inside” the item also moving in the namespace; no tombstone is created for entities “cascade moved.” This will require the addition of a path creation version inside _ChangeInformation.SyncInformation. The PathCreationVersion can represent the creation version (partner key, partner ts) at the creation time of the path. Sync will have the ability to set this (as it is stored inside _ChangeInformation.SyncInformation). Since move can result in new paths for entities “cascade moved”, the PathCreationVersion for cascade moved entities can be updated. In yet another example, EntityExtension delete can create a tombstone for the EntityExtension being deleted. With a Link delete, a tombstone can be created for the Link being deleted. While with an Item fragment delete, a tombstone can be created for the ItemFragment being deleted.

For a tombstone resurrection, the tombstone component 510 explicitly performs the following set of operations if an application (e.g., sync and/or backup/restore) wants to perform a resurrection which essentially means retaining some item change tracking information from the tombstone and deleting the tombstone: 1) read the entity tombstone and store the relevant change tracking information; 2) delete the tombstone; and 3) create a new entity tombstone using the change tracking information read in 1).

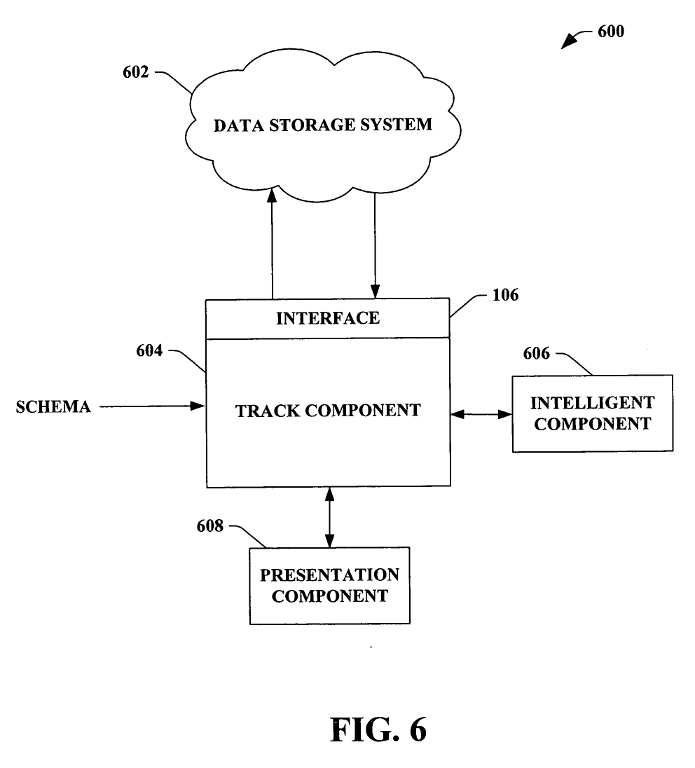

FIG. 6 illustrates a system 600 that employs intelligence to facilitate tracking a data change associated with a data storage system. The system 600 can include a data storage system 602, a track component 604, and an interface 106 that can all be substantially similar to respective components described in previous figures. The system 600 further includes an intelligent component 606. The intelligent component 606 can be utilized by the track component 604 to facilitate tracking a data change within the data storage system at an entity level and/or a sub-entity level based at least in part upon whether the entity participates in synchronization. For example, the intelligent component 606 can be utilized to analyze a data change, a schema, an entity to facilitate tracking a data change.

It is to be understood that the intelligent component 606 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

A presentation component 608 can provide various types of user interfaces to facilitate interaction between a user and any component coupled to the track component 604. As depicted, the presentation component 608 is a separate entity that can be utilized with the track component 604. However, it is to be appreciated that the presentation component 608 and/or similar view components can be incorporated into the track component 604 and/or a stand-alone unit. The presentation component 608 can provide one or more graphical user interfaces (GUIs), command line interfaces, and the like. For example, a GUI can be rendered that provides a user with a region or means to load, import, read, etc. data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such vertical and/or horizontal scroll bars for navigation and toolbar buttons to determine whether a region will be viewable can be employed. For example, the user can interact with one or more of the components coupled to the track component 604.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the invention is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

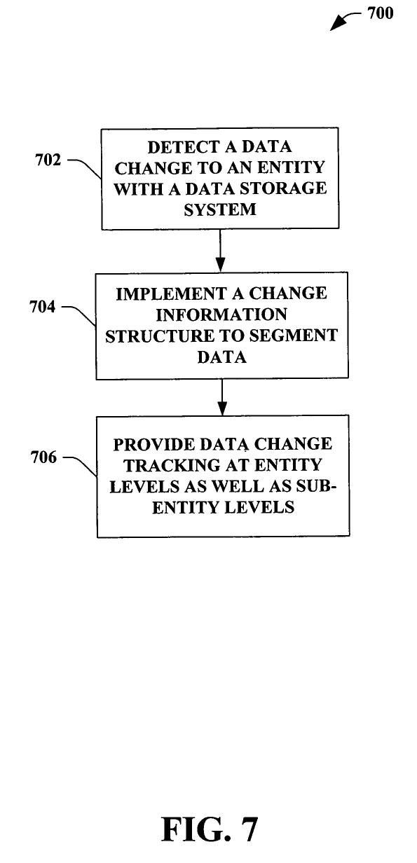

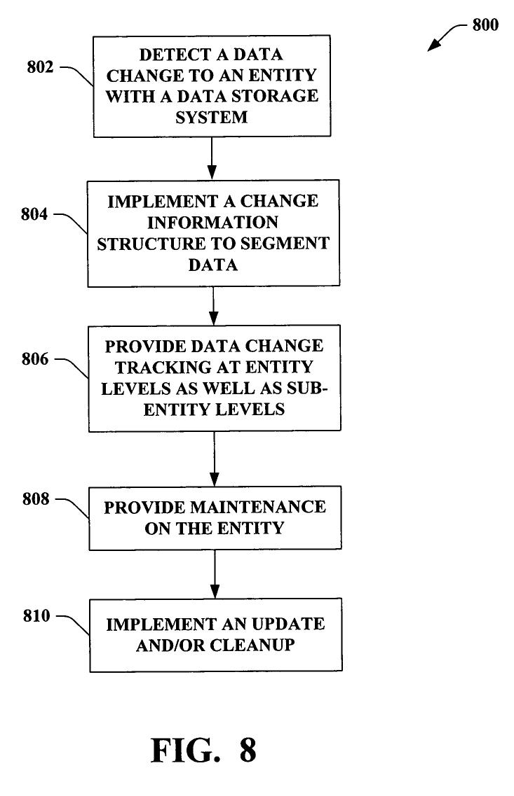

FIGS. 7-8 illustrate methodologies in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 7 illustrates a methodology 700 for tracking data changes in a data storage system. At reference numeral 702, a data change to an entity within a data storage system can be detected. The data storage system can be a database-based file storage system, wherein an item, a sub-item, a property, and a relationship are defined to allow the representation of information as instances of complex types. The data storage system can utilize a set of basic building blocks for creating and managing rich, persisted objects and links between objects. In one example, the data change can be a set, a copy, an update, a replace, a get, a set, a create, a delete, a move, etc. For instance, the entity can be an item, an extension, a link, a relationship, etc.

At reference numeral 704, a change information structure can be implemented to segment the data to provide the tracking of entities and sub-entity levels. Basic information for all entities (e.g., items, relationships, and extensions) regardless of participation in a sync relationship can be tracked and/or captured. Yet, when an entity participates in a sync relationship, additional information about the details of the partner stores that created or updated an entity are captured. The change information structure can carefully segment the data captured for generic change tracking from the data captured for the exclusive use of sync infrastructure. A schema definition language can provide annotation facilities in the type declaration to group a set of properties in an Item, Relationship, or Extension into logical units called Change Units. The change unit groups a set of properties into a logical unit on which change information can be captured in a store within the data storage system. By utilizing the change information structure, changes at sub-entity levels can be detected, captured, and/or tracked.

At reference numeral 706, data change tracking is provided at entity levels and/or sub-entity levels. By utilizing the change information structure, data changes at the entity levels as well as the sub-entity levels can be captured to facilitate the synchronization of minimal amount of data that was affected. In other words, the change information structure allows a granular tracking of a data change within a data storage system based at least in part upon a participation in a sync relationship.

FIG. 8 illustrates a methodology 800 that facilitates tracking data changes at entity and sub-entity levels for all entities stored in a data storage system. At reference numeral 802, a data change to an entity within a data storage system can be detected. The data storage system can be a database-based file storage system, wherein an item, a sub-item, a property, and a relationship are defined to allow the representation of information as instances of complex types. At reference numeral 804, a change information structure can be implemented to carefully segment the data captured for generic change tracking from the data captured for the exclusive use of sync infrastructure. The change information structure can capture data changes at the entity levels and at sub-entity levels to facilitate the synchronization of minimal amount of data that was affected with the change. In other words, the synchronization of data can be proportional to the data change based at least in part upon the granular data change. At reference numeral 806, the tracking and/or capturing of a data change can be provided at entity levels as well as a sub-entity level when the entity participates in a sync relationship.

Continuing at reference numeral 808, maintenance on the entity can be provided. Once the entity participates in a sync relationship, the additional change information is captured at the entity level and at the sub-entity level. Yet, the maintenance on the entity can include possible updates relating to the capturing of data, properties for notifications, properties for optimistic concurrency control, etc. At reference numeral 810, an update and/or cleanup can be implemented in relation to the tracking of data changes within the data storage system. The update can provide the status of sync participation and act accordingly. For example, the entity can participate in a sync relationship (wherein sub-entity level tracking occurs) and later not participate in the sync relationship (wherein the sub-entity level tracking is disabled). The cleanup can detect orphaned sync information enabled entities and delete such entities.

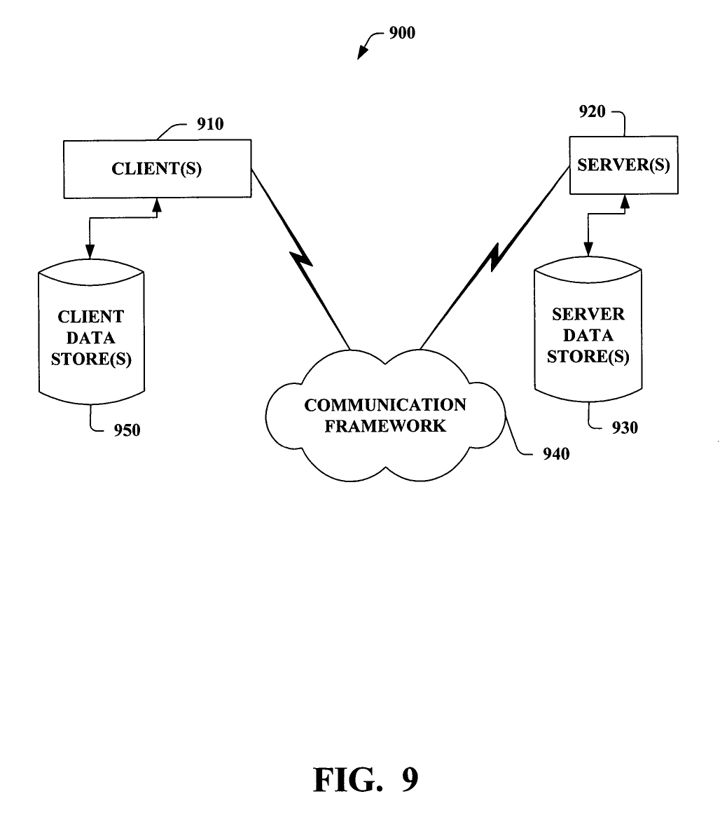

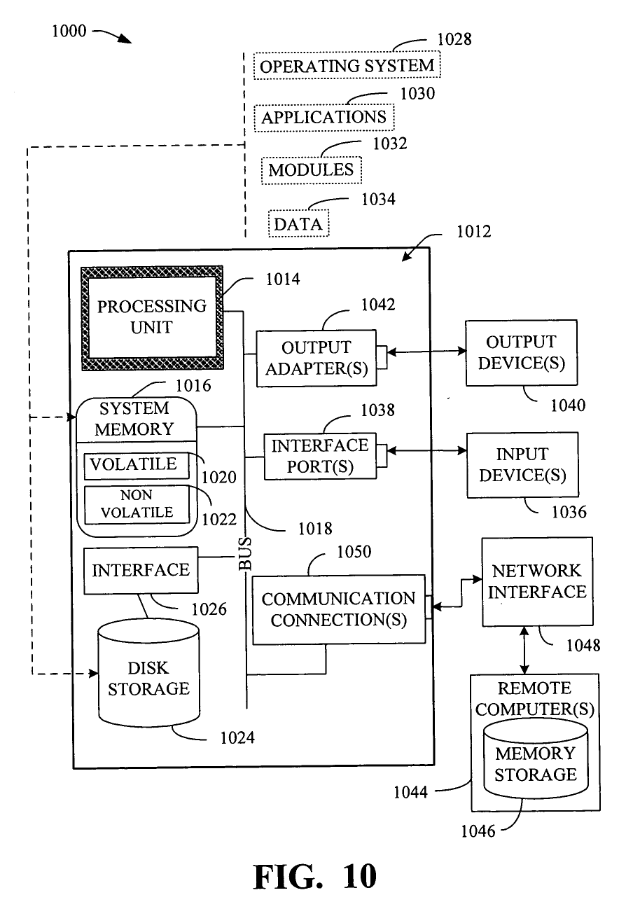

In order to provide additional context for implementing various aspects of the subject invention, FIGS. 9-10 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 9 is a schematic block diagram of a sample-computing environment 900 with which the subject invention can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject invention, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 940.

With reference to FIG. 10, an exemplary environment 1000 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates tracking data changes, comprising:
an interface that can receive at least one data change to an entity within a data storage system that in part represents complex instances of types; and
a track component that tracks additional data change information of one or more sub-entity levels of the entity when the entity participates in a synchronization (sync) relationship.

2. The system of claim 1, the data storage system is a database-based system that defines at least one of an item, a sub-item, a property, and a relationship to represent information as a complex type.

3. The system of claim 1, the data change is at least one of a copy, an update, a replace, a get, a set, a create, a delete, a move, and a modify.

4. The system of claim 1, entity is at least one of an item, a relationship, an extension, an item extension, a link, and an item fragment.

5. The system of claim 1, further comprising a non-sync component that tracks at least one of a creation local time stamp, a last update local time stamp, and a sync information related to the entity.

6. The system of claim 1, further comprising a sync component that tracks at least one of a creation partner key, a creation partner time stamp, a last update partner key, a deletion coordinated universal time (UTC), and a change unit version related to the entity when participating in a sync relationship.

7. The system of claim 1, further comprising a change unit that groups a set of properties into a logical unit on which data change information can be captured.

8. The system of claim 7, the change unit is provided by a schema that annotates a facility in a type declaration to group the set of properties in at least one of an item, a relationship, and an extension.

9. The system of claim 1, further comprising a view component that can project the change information related to a tracking of a data change in a column for at least one entity in an entity table associated with the data storage system.

10. The system of claim 1, further comprising a metadata component that maintains a structure that stores the mapping of an entity identification and global entity identification for the entity participating in synchronization.

11. The system of claim 1, further comprising a non-sync maintenance component that maintains a creation local time stamp and a last update local time stamp for the entity to be utilized with at least one of a notification and an optimistic concurrency control.

12. The system of claim 1, further comprising a sync maintenance component that maintains a sync information related to an entity when a subsequent update is invoked.

13. The system of claim 1, further comprising a generate component that generates a default sync change information structure for the entity when such entity starts participation in a sync relationship.

14. The system of claim 13, the generate component pre-computes a default sync change information object for each type of object installed in the data storage system during a schema installation.

15. The system of claim 1, further comprising an update component that provides a status of sync participation for the entity to allow the tracking of sub-entity levels.

16. The system of claim 1, further comprising a cleanup component that deletes an orphan sync information enabled entity.

17. A computer readable medium having stored thereon the components of the system of claim 1.

18. A computer-implemented method that facilitates tracking data changes, comprising:
detecting a data change to an entity within a data storage system that is a database-based file storage system that represents information as complex instances of types;
implementing a change information structure to segment data;
segmenting the data captured for generic change tracking from the data captured for the exclusive use of sync infrastructure; and
providing a data change tracking at an entity level and a sub-entity level based at least in part upon a sync relationship.

19. A data packet that communicates between a track component and an interface, the data packet facilitates the method of claim 18.

20. A computer-implemented system that facilitates tracking data changes, comprising:
means for receiving at least one data change to an entity within a data storage system that in part represents complex instances of types; and
means for tracking additional data change information of one or more sub-entity levels of the entity when the entity participates in a synchronization (sync) relationship.
